(19) United States
(12) Patent Application Publication
(10) Pub. No.: US 2012/0308826 A1
(43) Pub. Date: Dec. 6, 2012

(54) STOBER METHOD FOR PREPARING SILICA PARTICLES CONTAINING A PHTHALOCYANINE DERIVATIVE, SAID PARTICLES AND THE USES THEREOF

(75) Inventor: Aurélien Auger, Le Mans (FR)

(73) Assignee: Commissariat a l'energie atomique et aux energies alternatives, Paris (FR)

(21) Appl. No.: 13/578,554

(22) PCT Filed: Feb. 10, 2011
(86) PCT No.: PCT/EP2011/051924

§ 371 Date: Aug. 15, 2012

(30) Foreign Application Priority Data
Feb. 11, 2010 (FR) 10 50981

(51) Int. Cl. C09B 47/30

(52) U.S. Cl. 428/402; 540/128

(57) ABSTRACT

The present invention concerns a method for preparing a silica particle incorporating at least one phthalocyanine derivative, said particle being prepared from at least one silicon phthalocyanine derivative by hydrolysis of said derivative in an alcohol solution. The present invention also concerns the silica particles thus prepared and the uses thereof.

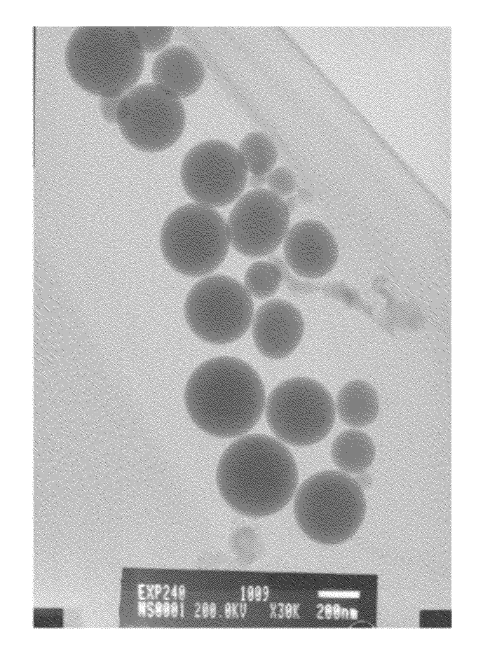

### TECHNICAL FIELD

The present invention relates to the field of silica particles and in particular silica nanoparticles containing dyes of silica phthalocyanine type.

Indeed, the subject of the present invention is a method for preparing silica particles incorporating derivatives of phthalocyanine and of naphthalocyanine. It also concerns the silica particles incorporating phthalocyanine and naphthalocyanine derivatives, able to be prepared with this method and their different uses and applications.

### STATE OF THE PRIOR ART

The synthesis and properties of dyes derived from complexes of silicon phthalocyanines or naphthalocyanines having axial ligands have been described in the literature by Kenney [1], Joyner [2], and Esposito [3]. Considerable interest in the physical and chemical properties of phthalocyanines has increased in recent years. This interest is due in part to their possible applications in various fields such as electrophotography [4], liquid crystals [5], conductive polymers [6], electrochromic display [7], photoelectrochemical energy conversion [8], infrared absorbing agents for transparent thermoplastics and cross-linked polymers [9] and photoconductivity [10].

Phthalocyanines and other macrocyclic analogues have drawn considerable attention as molecular materials having exceptional electronic and optical properties. These properties derive from delocalisation of the electron cloud, meaning that these products are of interest in different fields of research in the science of materials and most particularly in nanotechnology. For example, phthalocyanines have been successfully incorporated in semiconductor components, electrochromic devices, data storage systems.

One crucial problem to be taken into account when incorporating phthalocyanines in technological devices is the controlling of the spatial arrangement of these macrocycles. This makes it possible to extend and improve the chemical and physical properties of phthalocyanines on macromolecular or molecular scale. The co-facial stacking of phthalocyanines is required to obtain supramolecular properties. For example, increased conductivity can be obtained along the main axis of the stacking systems of phthalocyanines by delocalising electrons through co-planar macrocycles. Conductivity in systems containing phthalocyanines is generally dependent on the most particular intrinsic properties of phthalocyanines. For example, silicon phthalocyanines have been used to prepare devices such as field effect transistors. Good conductivity is also obtained in polymers containing phthalocyanines. Among a large variety of semiconductor polymers containing phthalocyanines, the most important family is the phthalocyanine siloxane family [PcSiO₂]ₙ.

Therefore, nano-objects and other polymers of phthalocyanine siloxanes are well known from the prior art. These structures are prepared in various manners in the literature. Several methods have been validated for polymerising silica phthalocyanine.

The preparation of phthalocyanine polysiloxanes has been described in the literature. For example, polymers have been synthesised using silicon phthalocyanines as precursors. These compounds enter into the preparation of Langmuir-Blodgett films, single-dimensional films of highly rigid polymer type [11]. Polymerisation is conducted in a vacuum at 350-400° C. for 2 h, conditions that are very extreme. Another synthesis of polymers is performed using the same silicon phthalocyanine precursor in dimethylsulfoxide at 135° C. for 24 h [12]. More recently, a new, more expedient protocol has been reported to prepare oligomers with 3 to 4 monomer units (silicon phthalocyanine) [13], said protocol comprising the condensation of the monomers in the presence of quinoline followed by silylation with tert-butyldimethylsilyl chloride (TBDMSCl).

Another approach has been developed to obtain a polymer cross-linked axially to the plane of the aromatic macrocycle of phthalocyanine. Therefore, axial functionalization led to obtaining a silicon phthalocyanine axially conjugated with a poly(sebacic acid) polyanhydride. The product thus obtained was then used to form hydrophilic nanoparticles via a reverse microphase method [14].

It is to be pointed out that in general these polymers produce high electric conductivities. However, these materials are insoluble both in water and in common organic solvents, making their industrial preparation difficult. The organic nature of the aromatic macrocycles of phthalocyanine type means that the latter are highly insoluble. The insolubility is more marked when using naphthalocyanines or anthracene analogues. This phenomenon is partly due to the aggregates formed by π-π interactions. It is therefore sometimes necessary to substitute the aromatic macrocycle at peripheral and/or non-peripheral positions to impart good solubility to this family of dyes in organic solvents. Unfortunately, this functionalization can lead to changes in the intrinsic properties. For example, in some cases it is preferable to maintain the aromatic network of the non-substituted macrocycle.

The encapsulation of silicon phthalocyanines has also been the subject of some research. Having regard to the marked and known hydrophobia of phthalocyanine-containing materials, their encapsulation in silica nano-objects is most difficult using a conventional wet process.

For example, a derivative of silicon phthalocyanine bisoleate has been inserted in lipoprotein nanoparticles so that these products can be used as lipoprotein-based nanoplatforms. These compounds were then used as multifunctional and therapeutic diagnosis devices [15]. A patent application also describes the encapsulating of crystals of copper phthalocyanines (no presence of silicon is mentioned) [16]. The study of the nanoparticles thus prepared for dispersion-containing inks, for colour filters and the composition of dyed and photosensitive resins has also been reported [17].

Another study describes the formation of nanoparticles of cadmium selenide (CdSe) combined with silicon phthalocyanines. The surface of the CdSe nanoparticles is therefore functionalized by condensation of the active group (amine group), located at axial position of the silicon phthalocyanine macrocyle and linked thereto via an alkyl group [18]. A similar study published in 2006 describes the insertion of copper phthalocyanine tetrasulfonate on the surface of silica nanoparticles modified by functionalization with amine groups [19].

International application WO 2008/138727 reports on the preparation of silica nanoparticles functionalized with copper phthalocyanine. The siloxane function carried by the copper phthalocyanine and needed for forming silica nanoparticles lies in peripheral position and requires a functionalization step of the copper phthalocyanine [20].

Finally, in 2006, nanoparticles of phthalocyanines were designed and synthesized for the distribution of hydrophobic photosensors developed for photodynamic therapy against cancer. The gold nanoparticles stabilizing the phthalocyanines have a mean diameter of 2 to 4 nm. The phthalocyanines are present on the surface of the gold nanoparticles and are functionalized with thiolated groups (—SH). The thiol function therefore provides the necessary reactivity for covalent assembly of the photosensor on the surface of the gold nanoparticles [21].

The prior art methods for preparing phthalocyanine-containing materials mostly require several steps and/or the prior functionalization of the phthalocyanines, making use thereof difficult on an industrial scale.

There is therefore a true need for a simple, practical method which can be given industrial application for preparing phthalocyanine-containing materials such as silica particles.

### DISCLOSURE OF THE INVENTION

The present invention is able to remedy the above-listed technical problems and disadvantages. Indeed, the invention proposes a method for preparing spherical, particulate silica materials, and in particular nanoparticle materials incorporating derivatives of phthalocyanine, said method can be applied on an industrial level, not requiring any cumbersome processes or steps and using products that are easily accessible, non-hazardous and scarcely toxic.

The work by the inventors has evidenced that the use of derivatives of silicon phthalocyanines as precursors of silica allows the fabrication of silica particles such as silica nanoparticles incorporating phthalocyanine derivatives. The availability of the axial ligands such as hydroxyls or chlorides, combined with the presence of the silica atom inserted into the cavity of the phthalocyanine macrocycle, enables the use of the latter as precursor needed for proper synthesis of silica nanoparticles via the conventional Stöber method.

Indeed, phthalocyanine has a central cavity allowing the incorporation of a large number of atoms, such as silicon. Since the silicon atom is tetravalent and requires two bonds for its incorporation in the cavity and the plane of the phthalocyanine aromatic macrocycle, two bonds remain available. These two bonds are axial to the plane defined by the silicon atom and the phthalocyanine, and are generally terminated by functions of hydroxyl or chloride type. These functions being reactive, they take part as reagents in the sol-gel synthesis of silica nanoparticles.

The synthesis via the Stöber route used in the present invention is more suitable for the preparation of large quantities of silica, also lending itself more to the preparation of industrial quantities of materials intended for the marketing of a product. Preference is given to the quantity of material rather than control over the size of the nano-objects thus prepared.

In addition, in the present invention, the surface of the silica particles obtained using the method of the invention can be functionalized and is thereby able to have an influence on the polarity of the particles, and hence on the affinity with the solvent to be used depending on applications i.e. polar, non-polar, etc. and hence on desired dispersion.

The present invention therefore concerns a method for preparing a silica particle incorporating at least one derivative of phthalocyanine, said particle being prepared from at least one silicon phthalocyanine derivative by hydrolysis of said silicon phthalocyanine derivative in an alcohol solution.

The method implemented for preparing the silica particles in the present invention uses the conventional Stöber type method described in the article by Stöber et al., 1968 [22]. This technique consists in hydrolysing a silane derivative in an alcohol.

In the present invention, the expressions <<silicon phthalocyanine derivative>> and <<silane phthalocyanine derivative>> are equivalent and can be used interchangeably.

By <<silicon phthalocyanine derivative>> is meant a compound of formula (I):

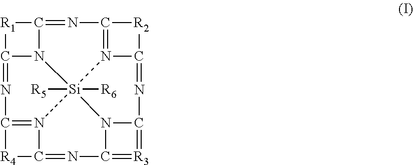

in which:
R₁, R₂, R₃ and R₄, the same or different, are an arylene group, optionally substituted, and
R₅ and R₆, the same or different, are chosen from the group formed by —Cl, —F, —OH and —OR′ where R′ is a straight-chain or branched alkyl having 1 to 12 carbon atoms, in particular 1 to 6 carbon atoms, optionally substituted.

By <<optionally substituted>> with regard to alkyl groups of compounds of formula (I), is meant substituted by a halogen, an amine group, a diamine group, an amide group, an acyl group, a vinyl group, a hydroxyl group, an epoxy group, a phosphonate group, a sulfonic acid group, an isocyanate group, a carboxyl group, a thiol (or mercapto group), a glycidoxy group or an acryloxy group and in particular a methacryloxy group. Advantageously, R′ is a methyl or an ethyl.

By <<arylene group>> in the present invention is meant an aromatic or heteroaromatic carbon structure, optionally mono- or polysubstituted, formed of one or more aromatic or heteroaromatic rings each comprising 3 to 8 atoms, the heteroatoms possibly being N, O, P or S.

By <<optionally substituted>> is meant an arylene group which may be mono- or polysubstituted by a group chosen from the group consisting of a carboxylate; an aldehyde; an ester; an ether; a hydroxyl; a halogen; an aryl such as a phenyl, benzyl or naphthyl; an alkyl, straight-chain or branched having 1 to 12 carbon atoms and in particular 1 to 6 carbon atoms, optionally substituted, such as a methyl, an ethyl, a propyl or hydroxypropyl; an amine; an amide; a sulfonyl; a sulfoxide and a thiol.

Advantageously the groups R₁, R₂, R₃ and R₄, the same or different, each represent a phenylene, a naphthylene or an anthracene. More particularly, the groups R₁, R₂, R₃ and R₄ are the same and represent a phenylene, a naphthylene or an anthracene.

In particular, the silicon phthalocyanine derivative used in the present invention is a compound of formula (II):

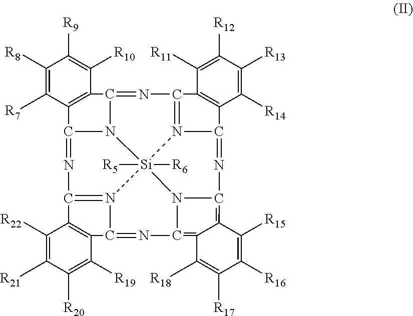

in which:
the groups R₇ to R₂₂, the same or different, are chosen from the group consisting of a hydrogen; a carboxylate; an aldehyde; a ketone; an ester; an ether; a hydroxyl; a halogen; an aryl such as a phenyl, benzyl or naphthyl; an alkyl, straight-chain or branched having 1 to 12 carbon atoms, in particular 1 to 6 carbon atoms, optionally substituted such as a methyl, an ethyl, a propyl or a hydroxypropyl; an amine; an amide; a sulfonyl; a sulfoxide and a thiol.
the groups R₅ and R₆ are such as previously defined.

One preferred formula (II) compound in the present invention is the compound in which the groups R₇ to R₂₂ represent a hydrogen and the groups R₅ and R₆ are such as previously defined.

As a variant, the silicon phthalocyanine derivative used in the present invention is a compound of formula (III) of naphthalocyanine type:

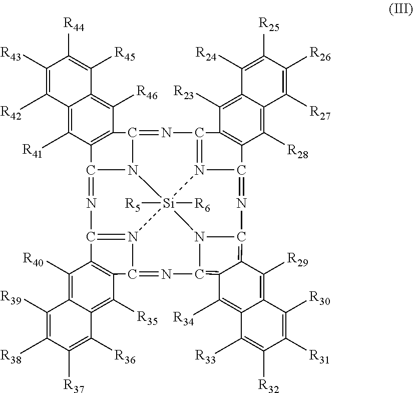

in which:
the groups R₂₃ to R₄₆, the same or different, are chosen from the group consisting of a hydrogen; a carboxylate; an aldehyde; a ketone; an ester; an ether; a hydroxyl; a halogen; an aryl such as a phenyl, benzyl or naphthyl; an alkyl, straight-chain or branched having 1 to 12 carbon atoms, in particular 1 to 6 carbon atoms, optionally substituted such as a methyl, an ethyl, a propyl or a hydroxypropyl; an amine; an amide; a sulfonyl; a sulfoxide and a thiol.
the groups R₅ and R₆ are such as previously defined.

One preferred formula (III) compound in the present invention is the compound in which the groups R₂₃ to R₄₆ represent a hydrogen and the groups R₅ and R₆ are such as previously defined.

In formulas (I), (II) and (III), the bonds shown as a dotted line are coordination bonds or dative bonds.

Advantageously, the groups R₅ and R₆ in the compounds of formula (I), (II) or (III) are the same and are chosen from the group consisting of —Cl, —F, —OH and —OR′ where R′ represents an alkyl, straight-chain or branched having 1 to 12 carbon atoms and in particular 1 to 6 carbon atoms, optionally substituted and chosen in particular from the group consisting of —Cl, —F, —OH, —OCH₃ and —OC₂H₅. More particularly, the groups R₅ and R₆ in the compounds of formula (I), (II) or (III) are the same and represent —OH or —Cl.

The compounds of formula (II) and (III) that are given most particular use in the present invention are a phthalocyaninatodichlorosilane complex, a phthalocyaninadihydroxysilane complex, a naphthalocyaninatodichlorosilane complex and a naphthalocyaninatodihydroxysilane complex. These complexes can be represented with R representing —OH or —Cl in the following manner:

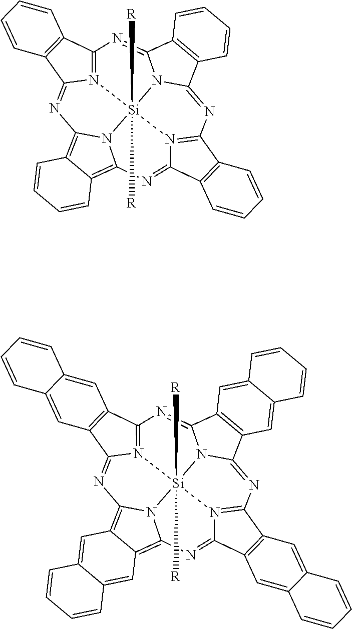

The method of the invention more particularly comprises the following successive steps:

a) preparing a first solution (Sₐ) containing at least one silicon phthalocyanine derivative and optionally at least one silane compound,

b) adding to the solution (Sₐ) obtained at step (a), a second solution (S′) containing at least one compound allowing the hydrolysis of silane compounds and at least one alcohol,

c) adding to the solution (S_{b}) obtained at step (b) a solvent which allows de-stabilisation of said solution,

d) recovering the silica particles incorporating at least one silicon phthalocyanine derivative which were precipitated at step (c).

Step (a) of the method of the invention therefore consists in preparing a solution (Sₐ) containing at least one silicon phthalocyanine derivative, in particular such as defined above. Any technique allowing the preparation of said solution can be used in the present invention.

Advantageously, the solution (Sₐ) is obtained at step (a) of the method of the invention by mixing together:
at least one silicon phthalocyanine derivative,
at least one polar solvent, and
optionally at least one silane compound.

Advantageously, the silicon phthalocyanine derivative, the polar solvent and the optional silane compound are added one after the other and in the following order: silicon phthalocyanine derivative followed by polar solvent then the optional silane compound.

By <<polar solvent>> in the present invention is meant a solvent chosen from the group consisting of acidified or basic water, de-ionized water or distilled water; hydroxylated solvents such as methanol, ethanol and isopropanol; liquid glycols of low molecular weight such as ethyleneglycol, dimethylsulfoxide (DMSO), acetonitrile, acetone, tetrahydrofuran (THF) and mixtures thereof. Advantageously, solution (Sₐ) is an alcohol solution and the polar solvent of solution (Sₐ) is a hydroxylated solvent such as methanol, ethanol and isopropanol. More particularly, the polar solvent of solution (Sₐ) is ethanol. More particularly, solution (Sa) is an alcohol solution which, in addition to the hydroxylated solvent such as defined above, contains a co-solvent of THF type to solubilize the silicon phthalocyanine derivative.

The silicon phthalocyanine derivative(s) can be used at step (a) of the method of the invention in solid form, in liquid form or in solution in a polar solvent. If several different silicon phthalocyanine derivatives are used they can be mixed all at once, or added one after the other, or per group.

If the silicon phthalocyanine derivative(s) is (are) used in solution in a polar solvent, this solvent may be the same as or different from the polar solvent of solution (Sₐ). Advantageously, the polar solvent used to dissolve the silicon phthalocyanine derivative(s) is different from the polar solvent of solution (Sₐ). The polar solvent used to dissolve the silicon phthalocyanine derivative(s) is more particularly THF.

The mixing at step (a) is performed under agitation using an agitator, a magnetic bar, an ultrasound bath or a homogenizer, and can be conducted at a temperature of between 10 and 40° C., advantageously between 15 and 30° C. and, more particularly, at ambient temperature (i.e. 23° C.±5° C.)

In solution (Sₐ), the silicon phthalocyanine derivative or the mixture of silicon phthalocyanine derivatives has a molarity of between 50 μM and 100 mM, in particular between 100 μM and 50 mM and more particularly between 1 mM and 10 mM. The polar solvent or the mixture of polar solvents (polar solvent in which the silicon phthalocyanine derivative(s) is(are) in solution and/or other polar solvent of solution (Sₐ)) is present in solution (Sₐ) in a proportion of between 60 and 100%, in particular between 70 and 90% and more particularly between 75 and 85% by volume relative to the total volume of said solution.

The presence in solution (Sₐ) of a silane compound or of several silane compounds is optional. When a silane compound or several silane compounds, the same or different, are present, they are incorporated in the solution (Sₐ) to yield, just like the silicon phthalocyanine derivative(s), the silica of the silica particles of the invention by sol-gel reaction.

The silane compound(s) can be added to the solution (Sₐ) in solid form, in liquid form or in solution in a polar solvent. When several different silane compounds are used, they can be mixed all at once, or added one after the other, or per group.

When the silane compound(s) is(are) used in solution in a polar solvent, this solvent may be the same as or different from the polar solvent of the solution (Sₐ). It may also be the same as or different from the polar solvent used to dissolve the silicon-phthalocyanine derivative(s).

Advantageously, the silane compound(s) is(are) added to the solution (Sₐ) in liquid form. In the solution (Sₐ), the silane compound(s) is(are) present in a proportion of between 0.1 and 40%, in particular between 1 and 30%, more particularly between 5 and 25% by volume relative to the total volume of said solution.

In the solution (Sₐ), the silane compound(s) has(have) a molarity of between 50 μM and 100 mM, particularly between 100 μM and 50 mM, more particularly between 1 mM and 10 mM.

Advantageously, said silane compound(s) are of general formula SiRₐR_{b}R_{c}R_{d} where Rₐ, R_{b}, R_{c} and R_{d}, independently of each other, are chosen from the group consisting of a hydrogen; a halogen; an amine group; a diamine group; an amide group; an acyl group; a vinyl group; a hydroxyl group; an epoxy group; a phosphonate group; a sulfonic acid group; an isocyanate group; a carboxyl group; a thiol (or mercapto) group; a glycidoxy group; an acryloxy group such as a methacryloxy group; an alkyl group, straight-chain or branched, optionally substituted, with 1 to 12 carbon atoms, in particular 1 to 6 carbon atoms; an aryl group, straight-chain or branched, optionally substituted, having 4 to 15 carbon atoms, in particular 4 to 10 carbon atoms; an alkoxy group of formula —ORₑ where Rₑ represents an alkyl group such as previously defined, and the salts thereof.

By <<optionally substituted>> with regard to alkyl and aryl groups of the silane compounds is meant substituted by a halogen, an amine group, a diamine group, an amide group, an acyl group, a vinyl group, a hydroxyl group, an epoxy group, a phosphonate group, a sulfonic acid group, an isocyanate group, a carboxyl group, a thiol (or mercapto) group; a glycidoxy or acryloxy group and in particular a methacryloxy group.

In particular, said silane compound(s) is(are) alkylsilane(s) and/or alkoxysilane(s). Therefore, the silane compound is more particularly chosen from the group consisting of dimethylsilane (DMSi), phenyltriethoxysilane (PTES), tetraethoxysilane (TEOS), tetramethoxysilane (TEMOS), n-octyltriethoxysilane, n-octadecyltriethoxysilane, dimethyldimethoxysilane (DMDMOS), (3-mercaptopropyl)trimethoxysilane, (3-mercaptopropyl)triethoxysilane, (mercapto)-triethoxysilane, (3-aminopropyl)triethoxysilane, 3-(2-aminoethylamino)propyltrimethoxysilane, 3-[bis(2-hydroxyethyl)amino]propyltriethoxysilane, hexadecyltrimethoxysilane, phenyltrimethoxysilane, N-[3-(trimethoxysilyl)propyl]-1,2-ethanediamine and acetoxyethyltriethoxysilane, 2-hydroxy-4-(3-triethoxysilylpropoxy)diphenylketone, methyl-triethoxysilane, vinyltrimethoxysilane, (3-glycidoxypropyl)trimethoxysilane, (benzoyloxypropyl)trimethoxysilane, sodium 3-trihydroxysilylpropylmethylphosphonate, (3-trihydroxysilyl)-1-propanesulfonic acid, (diethylphosphonatoethyl)triethoxysilane, and the mixtures thereof. More particularly, the silane compound is tetraethoxysilane (TEOS, Si(OC₂H₅)₄).

To functionalize the surface of the silica particles obtained with the invention, the silane compound used may be a mixture containing less than 20% and in particular from 5 to 15% of pre-functionalized silane in relation to the total quantity of silane compounds. For example, a mixture containing TEOS and 5 to 15% of mercaptotriethoxysilane can be used to prepare the silica particles of the invention and functionalized by thiol groups.

Step (b) of the method of the invention concerns the hydrolysis of a silane compound in an alcohol solution by adding a compound to the solution (Sₐ) which allows this hydrolysis and an alcohol in the form of an alcohol polar solvent.

Step (b) consists more particularly in adding, to solution (Sₐ), a solution (S′) that is obtained by mixing together:
optionally at least one non-alcohol polar solvent,
at least one alcohol polar solvent, and
at least one compound allowing the hydrolysis of the silane compound.

Advantageously the optional non-alcohol polar solvent(s), the alcohol polar solvent(s) and the compound(s) allowing the hydrolysis of the silane compound are added one after the other and in the following order:
optional non-alcohol polar solvent(s), then
alcohol polar solvent(s), then
optional non-alcohol polar solvent(s), the same as or different from the optional non-alcohol polar solvent(s) previously added, then
compound(s) allowing the hydrolysis of the silane compound.

Solution (S′) can be prepared before, after or simultaneously with step (a) of the method according to the present invention. Advantageously, the solution (S′) is prepared prior to step (a) of the method according to the present invention.

The optional non-alcohol polar solvent(s) are chosen from the group consisting of acidified or basic water, de-ionized water, distilled water; liquid glycols of low molecular weight such as ethyleneglycol, dimethylsulfoxide (DMSO), acetonitrile, acetone, tetrahydrofuran (THF) and mixtures thereof.

Advantageously, the non-alcohol polar solvents present in the solution (S′) are water, in particular de-ionized water, and THF. More particularly, when preparing the solution (S′), the alcohol polar solvent is mixed with water in particular de-ionized water before adding THF.

The optional non-alcohol polar solvent(s) is(are) present in the solution (S′) in a proportion of between 30 and 80%, in particular between 40 and 70% and more particularly between 50 and 60% by volume relative to the total volume of the solution (S′).

The alcohol polar solvent(s) correspond(s) to the hydroxylated solvent(s) such as methanol, ethanol and isopropanol. More particularly, the alcohol polar solvent of solution (S′) is ethanol.

The optional alcohol polar solvent(s) is(are) present in the solution (S′) in a proportion of between 10 and 95%, in particular between 20 and 70% and more particularly between 30 and 50% by volume relative to the total volume of the solution (S′).

It is to be pointed out that by <<compound allowing the hydrolysis of silane compounds>> is meant a compound not only allowing the hydrolysis of a silane compound but also the hydrolysis of a silicon phthalocyanine derivative.

The compound allowing the hydrolysis of a silane compound is advantageously chosen from the group consisting of ammonia, sodium hydroxide (KOH), lithium hydroxide (LiOH), sodium hydroxide (NaOH), triethylamine and pyridine and, advantageously, a solution of said compound in a polar solvent that is the same as or different from the polar solvent(s) used at step (a). The compound allowing the hydrolysis of the silane compound is more particularly ammonia or an ammonia solution in a polar solvent such as previously defined. Ammonia acts as reagent (H₂O) and as catalyst (NH₄OH) for the hydrolysis of the silane compound or of the silicon phthalocyanine derivative.

The compound allowing the hydrolysis of the silane compound, when it is in solution in a polar solvent, is present in a proportion of between 5 and 50%, in particular between 10 and 40% and more particularly between 20 and 30% by volume relative to the total volume of said solution.

In addition, said solution is present in a proportion of between 0.05 and 20%, in particular between 0.1 and 10% and more particularly between 0.5 and 5% by volume relative to the total volume of the solution (S′).

Step (b) of the method according to the present invention therefore consists in adding the solution (S′) to the solution (Sₐ) prepared at step (a). This addition is made slowly and in particular drop-wise.

The ratio [volume of Solution (Sₐ)]/[volume of Solution (S′)] is advantageously between 1/1 and 1/20, in particular between 1/2 and 1/10 and more particularly between 1/4 and 1/8.

Step (b) can be performed under agitation using an agitator, a magnetic bar, an ultrasound bath, or a homogenizer. Advantageously, this agitation is conducted once the adding of solution (S′) is completed. Step (b) can be conducted at a temperature of between 10 and 40° C., advantageously between 15 and 30° C. and more particularly at ambient temperature (i.e. 23° C.±5° C.) for a time of between 6 and 48 h, in particular between 12 and 36 h and more particularly for 24 h.

If the silane compound used is TEOS, the reaction which occurs at step (b) of the method i.e. the condensation of the silicon phthalocyanine derivative with TEOS in the presence of ammonia can be schematized as follows:

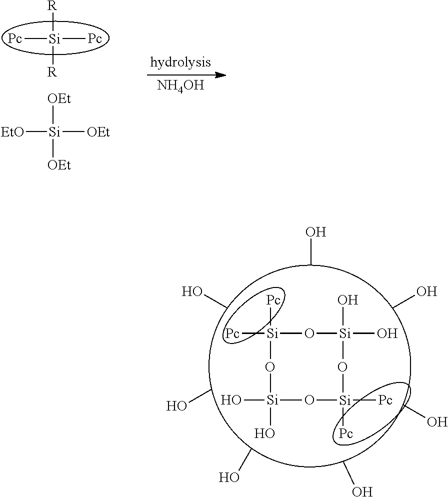

Step (c) of the method of the invention concerns the precipitation of the silica particles by adding a solvent which does not denature the structure of the particles but which destabilizes or denatures the solution (S_{b}) obtained at step (b).

Advantageously, the solvent used is a polar solvent such as previously defined. One particular polar solvent which can be used at step (c) is chosen from the group formed by ethanol, acetone and methanol. Advantageously, the solvent used at step (c) of the method according to the invention is ethanol. Therefore, to the solution (S_{b}), there is added a volume of solvent that is greater than the volume of said solution, in particular greater by a factor of 1.5; in particular greater by a factor of 2; even greater by a factor of 3.

Any technique allowing the recovery of the silica particles incorporating at least one derivative of phthalocyanine, and precipitated at step (c) can be used at step (d) of the method of the invention. Advantageously, this step (d) uses one or more steps, the same or different, chosen from among the steps of centrifugation, sedimentation and washings.

The washing step(s) is(are) conducted in a polar solvent such as previously defined. If the recovery step comprises several washings, one same polar solvent is used for several and even for all the washings or several different polar solvents are used for each washing.

With regard to one (or more) centrifugation step(s), this (these) can be implemented by centrifuging the silica particles in particular in a washing solvent at ambient temperature, at a speed of between 4000 and 8000 rpm and in particular of the order of 6000 rpm (i.e. 6000±500 rpm) for a time of between 5 min and 2 h, in particular between 10 min and 1 h and more particularly for 15 min.

Advantageously, step (d) of the method of the present invention consists of 4 successive washings, each followed by centrifugal sedimentation. More particularly, the 3 first washings are conducted with a hydroxylated solvent in particular with ethanol, and the last one with water.

The method of the present invention, after step (d), may comprise an additional step consisting in purifying the silica particles obtained, hereinafter designated <<step (e) >>.

Advantageously, this step (e) consists in placing the silica particles recovered after step (d) of the method of the invention in contact with a very large volume of water. By <<very large volume>> is meant a volume greater by a factor of 50, in particular by a factor of 500 and more particularly by a factor of 1000, than the volume of silica particles recovered after step (d) of the method of the invention. Step (e) can be a dialysis step, the silica particles being separated from the volume by a cellulose membrane of Zellu Trans® type (marketed by Roth). Alternatively, it is possible to make provision for an ultrafiltration step instead of the dialysis step, using a polyethersulfone membrane.

Step (e) can additionally be implemented under agitation using an agitator, a magnetic bar, an ultrasound bath or a homogenizer, at a temperature of between 0 and 30° C., advantageously between 2 and 20° C. and more particularly at a cold temperature (i.e. 6° C.±2° C.) for a time of between 30 h and 15 d, in particular between 3 d and 10 d and more particularly for one week.

The present invention also concerns the solution (S_{b}) which can be used in the method according to the invention. This solution comprises:
one (or more) alcohol polar solvent(s), in particular such as previously defined,
one (or more) non-alcohol polar solvent(s), in particular such as previously defined,
one (or more) silicon phthalocyanine derivative(s), in particular such as previously defined and typically of formula (I) such as previously defined,
optionally one (or more) silane compound(s), in particular such as previously defined, and
one (or more) compound(s) capable of hydrolysing a silane compound such as previously defined.

Advantageously, the solution (S_{b}) subject of the present invention comprises:
one (or more) alcohol polar solvent(s) in an amount of between 20 and 80% and in particular between 30 and 70%,
at least one non-alcohol polar solvent in an amount of between 15 and 75% and in particular between 20 and 65%,
one (or more) silicon phthalocyanine derivative(s) in an amount of between 10 μM and 20 mM, in particular between 20 μM and 10 mM and more particularly between 200 μM and 2 mM,
optionally at least one silane compound in an amount of between 10 μM and 20 mM, in particular between 20 μM and 10 mM and more particularly between 200 μM and 2 mM, and
at least one compound capable of hydrolysing a silane compound in an amount of between 0.1 and 10%, in particular 0.5 and 5% and more particularly between 1 and 3%,

the percentages being expressed in volume relative to the volume of said solution.

The present invention additionally concerns a silica particle able to be prepared using the method of the present invention. This particle is a silica particle containing at least one derivative of phthalocyanine, such as previously defined. It differs from the silica particles in the prior art by the two covalent bonds which link the silicon atom to the phthalocyanine derivative, the phthalocyanine derivative not being a group which functionalizes the silica particle. The particle of the invention therefore differs from the prior art silica particles at structural level precisely due to the two covalent bonds taking part in the silica network and to the central position of the silicon atom. This structural difference leads to large stability of the particles according to the invention that are thus obtained.

Advantageously, the silica particles of the invention are nanoparticles having a mean size of more than 100 nm. The silica particles of the invention are nanoparticles having a mean size of 105 nm or more, in particular of between 110 and 600 nm and more particularly of between 120 and 400 nm. Since the silica particles are advantageously spherical, the previously defined sizes correspond to the mean diameter of these particles. The silica particles of the invention may optionally be functionalized.

In addition, the silica particles of the invention may optionally be porous. For this purpose, a pore-forming agent such as those usually used can be added to the solution (Sₐ). As pore-forming agents which can be used, mention may be made of glycerol, 3-aminopropyltriethoxysilane, octadecyltrimethoxysilane (C18TMS), a precursor of platinum, a surfactant such as cetyltrimethoxyammonium bromide (CTAB) or a thermal pore-forming agent of adamantine type.

Finally, the present invention concerns the use of a silica particle according to the invention in fields chosen from the group formed by catalysis, printing, paints, filtration, polymerization, heat exchange, thermal stability, chemistry of materials, refining of hydrocarbons, hydrogen production, absorbents, food industry, the transport of active agents, biomolecules, pharmaceutical products, lagging, bioelectronic compounds and electronic, optical, semiconductor and sensor devices.

Other characteristics and advantages of the present invention will become more apparent to one skilled in the art on reading the examples given below as non-limiting illustrations with reference to the appended FIGURE.

### BRIEF DESCRIPTION OF THE DRAWINGS

The single FIGURE gives a view obtained by transmission electron microscopy (TEM) of silica nanoparticles prepared using the method of the invention.

### DETAILED DESCRIPTION OF PARTICULAR EMBODIMENTS

I. Method for Preparing Silica Nanoparticles According to the Invention

The preparation of two solutions is needed for the experiment, a first solution containing the hydrolysis agent (ammonia) in alcohol and a second ethanol solution containing the silane phthalocyanine derivative. The reaction mixture is prepared by mixing adequate quantities of ethanol, water and THF, aqueous ammonia solution and TEOS. The ammonia acts as reagent (H₂O) and as catalyst (NH₄OH) for the hydrolysis of TEOS.

A first solution (1) is generated by adding in this order the following chemical products: deionized water (2 mL), ethanol (5 mL), THF (6 mL) and 25% aqueous ammonia (1 mL).

This first solution (1) is added drop-wise to a second solution (2) prepared later, under magnetic agitation, and containing in this order the following chemical products: the silane phthalocyanine derivative (silicon naphthalocyanine dihydroxide, CAS No: 92396-90-2) dissolved in THF (10 mg at 775 g·mol⁻¹ in 1.25 mL of THF), ethanol (0.75 mL) and optionally TEOS (0.5 mL, d=0.934, M=208.33 g·mol⁻¹).

The second solution (2) contains the following chemical products in this order: the silane phthalocyanine derivative (silicon naphthalocyanine dihydroxide, CAS No: 92396-90-2) dissolved in THF (10 mg at 775 g·mol⁻¹ in 1.25 mL of THF) and ethanol (0.75 mL). It is this solution that is subsequently used.

As a variant, the solution (2) may contain, in this order, the following chemical products: the silane phthalocyanine derivative (silicon naphtalocyanine dihydroxide, CAS No: 92396-90-2) dissolved in THF (10 mg at 775 g·mol⁻¹ in 1.25 mL of THF), ethanol (0.75 mL) and TEOS (0.5 mL, d=0.934, M=208.33 g·mol⁻¹).

Once the addition of (1) is completed, the solution is left under agitation at ambient temperature for 24 h. The hydrolysis of the silane derivatives (phthalocyanine and TEOS) is initiated through the addition of the 25% aqueous ammonia.

The reaction mixture is de-stabilized by adding ethanol (200 mL) and the silica beads obtained are washed three times in ethanol and once in water, each washing being followed by centrifugal sedimentation (15 min at 6000 rpm).

After the washing step, the purification of the nanoparticles obtained was completed by dialysis in water (1 L) under magnetic agitation for one week.

II. Characterization of the Silica Nanoparticles According to the Invention

The silica nanoparticles dispersed in water (10 mL) prepared following the method of part I were then characterized by transmission electron microscopy (TEM) to ascertain the nanostructure of these nanoparticles.

Spherical nanoparticles were observed whose diameter varied between 120 and 400 nm (single FIGURE).

### REFERENCES

[1] U.S. Pat. No. 3,094,536 (Kenney) published on 18 Jun. 1963;
[2] Joyner, R. D.; Cekada, J.; Link Jr. R. G.; Kenney, M. E. J. Inorg. Nucl. Chem. 1960, 15, 387;
[3] Esposito, J. N.; Lloyd, J. E.; Keeney, M. E. Inorg. Chem. 1966, 5, 1979;
[4] Lotfy, R. O.; Hor, A. M.; Rucklidge, A. J. Imag. Sci. 1987, 31, 31;
[5] Belarbi, Z.; Sirlin, C.; Simon, J.; Andre, J. J. Phys. Chem. 1989, 93, 8105;
[6] Hanack, M. Mol. Cryst. Liq. Cryst. 1988, 160, 133;
[7] Castenada, F.; Plichon, V.; Clarisse, C.; Riou, M. T. J. Electroanal. Chem. 1987, 233, 77;
[8] Sims, T. D.; Pemberton, J. E.; Lee, P.; Armstrong, N. R. Chem. Mater. 1989, 1, 26;
[9] International publication WO 2008/083918 (CIBA HOLDING Inc. and CIBA SPA) published on 17 Jul. 2008;
[10] Hayashida, S.; Hayashi, N. Chem. Mater 1991, 3, 92;
[11] Chen, P.; Tang, D.; Wang, X.; Chen, H.; Liu, M.; Li, J.; Liu, X. Colloids and Surfaces A: Physicochemical and Engineering Aspects 2000, 175, 171;
[12] Nicolau, M.; Henry, C.; Martinez-Diaz, M. V.; Torres, T.; Armand, F.; Palacin, S.; Ruaudel-Teixier, A.; Wegner, G. Synthetic Metals 1999, 102, 1521;
[13] Cammidge, A. N.; Nekelson, F.; Helliwell, M.; Heeney, M. J.; Cook, M. J. J. Am. Chem. Soc. 2005, 127, 16382;
[14] Lee, P. P. S.; Ngai, T.; Wu, C.; Ng, D. K. P. Journal of Polymer Science: Part A: Polymer Chemistry 2005, 43, 837;
[15] Zheng, G.; Chen, J.; Li, H.; Glickson, J. D. PNAS, 2005, 102, 17757;
[16] Patent application JP2005-272760 (TOYO INK MFG CO) published on 6 Oct. 2005;
[17] Inomata H.; Arai K.; Nakanishi H. Jpn. J. Appl. Phys., 1999, 38, L81;
[18] Dayal, S.; Krolicki, R.; Lou, Y.; Qiu, X.; Berlin, J. C.; Kenney, M. E.; Burda, C. Appl. Phys. B 2006, 84, 309;
[19] Kim, T. H.; Lee, J. K.; Park, W. H.; Lee, T. S. Mol. Cryst. Liq. Cryst. 2006, 444, 23;
[20] International application WO 2008/138727 (CIBA HOLDING Inc.) published on 20 Nov. 2008;
[21] Wieder, M. E.; Hone, D. C.; Cook, M. J.; Handsley, M. M.; Gavrilovic, J.; Russell, D. A. Photochem. Photobiol. Sci. 2006, 5, 727;
[22] Stöber, W.; Fink, A.; Bohn, E. J. Colloid. Interface Sci. 1968, 26, 62.

1. A method for preparing a silica particle incorporating at least one derivative of phthalocyanine, said particle being prepared from at least one silicon phthalocyanine derivative by hydrolysis of said silicon phthalocyanine derivative in an alcohol solution, said silicon phthalocyanine derivative being a compound of formula (I): 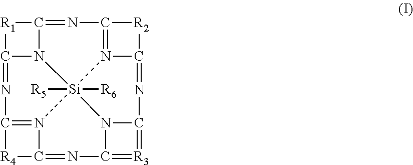
in which:
R₁, R₂, R₃ and R₄, the same or different, are an arylene group, optionally substituted, and
R₅ and R₆, the same or different, are selected from the group consisting of —Cl, —F, —OH and —OR′ where R′ represents an alkyl, straight-chain or branched, having 1 to 12 carbon atoms, optionally substituted.

2. The method according to claim 1, wherein said silicon phthalocyanine derivative is a compound of formula (II): 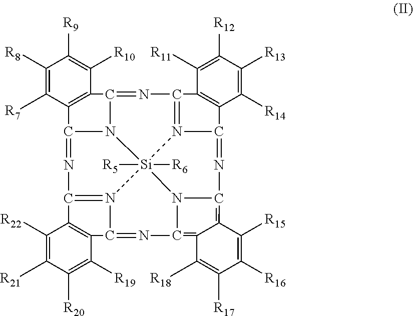
in which:
the groups R₇ to R₂₂, the same or different, are selected from the group consisting of a hydrogen; a carboxylate; an aldehyde; an ester; an ether; a hydroxyl; a halogen; an aryl; an alkyl, straight-chain or branched, having 1 to 12 carbon atoms, optionally substituted, an amine; an amide; a sulfonyl; a sulfoxide and a thiol;
the groups R₅ and R₆ are such as defined in claim 1.

3. The method according to claim 1, wherein said silicon phthalocyanine derivative is a compound of formula (III) of naphthalocyanine type: 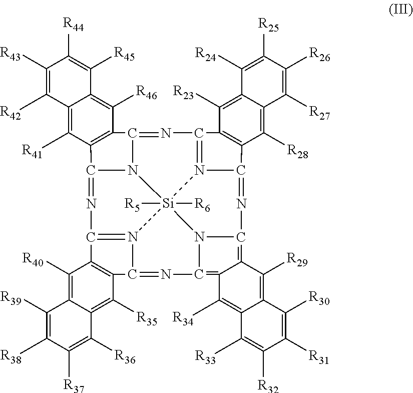
in which:
the groups R₂₃ to R₄₆, the same or different, are selected from the group consisting of a hydrogen; a carboxylate; an aldehyde; an ester; an ether; a hydroxyl; a halogen; an aryl; an alkyl, straight-chain or branched having 1 to 12 carbon atoms, optionally substituted, an amine; an amide; a sulfonyl; a sulfoxide and a thiol;
R₅ and R₆, the same or different, are selected from the group consisting of —Cl, —F, —OH and —OR′ where R′ represents an alkyl, straight-chain or branched, having 1 to 12 carbon atoms, optionally substituted.

4. The method according to claim 1, wherein said method comprises the following successive steps:
a) preparing a first solution (Sₐ) containing at least one silicon phthalocyanine derivative and optionally at least one silane compound,
b) adding, to the solution (Sₐ) obtained at step (a), a second solution (S′) containing at least one compound allowing the hydrolysis of silane compounds and at least one alcohol,
c) adding to the solution (S_{b}) obtained at step (b) a solvent allowing the de-stabilization of said solution,
d) recovering the silica particles incorporating at least one silicon phthalocyanine derivative, which were precipitated at step (c).

5. The method according to claim 4, wherein said solution (Sₐ) is obtained, at step (a), by mixing together at least one silicon phthalocyanine derivative, at least one polar solvent and optionally at least one silane compound.

6. The method according to claim 5, wherein said polar solvent is a hydroxylated solvent.

7. The method according to claim 4, wherein said silane compound(s) have the general formula:
SiRₐR_{b}R_{c}R_{d}
where Rₐ, R_{b}, R_{c} and R_{d}, independently of each other, are selected from the group consisting of a hydrogen; a halogen; an amine group; a diamine group; an amide group; an acyl group; a vinyl group; a hydroxyl group; an epoxy group; a phosphonate group; a sulfonic acid group; an isocyanate group; a carboxyl group; a thiol (or mercapto) group; a glycidoxy group; an acryloxy group; an alkyl group, straight-chain or branched optionally substituted, having 1 to 12 carbon atoms, an aryl group, straight-chain or branched, optionally substituted, having 4 to 15 carbon atoms, an alkoxy group of formula —ORₑ where Rₑ represents an alkyl group such as previously defined, and the salts thereof.

8. The method according to claim 4, wherein the said silane compound(s) are selected from the group consisting of dimethylsilane (DMSi), phenyltriethoxysilane (PTES) tetraethoxysilane (TEOS), tetramethoxysilane (TEMOS), n-octyltriethoxysilane, n-octadecyltriethoxysilane, dimethyldimethoxysilane (DMDMOS), (3-mercaptopropyl)trimethoxysilane, (3-mercaptopropyl)triethoxysilane, (mercapto)-triethoxysilane, (3-aminopropyl)triethoxysilane, 3-(2-aminoethylamino)propyltrimethoxysilane, 3-[bis(2-hydroxyethyl)amino]propyltriethoxysilane, hexadecyltrimethoxysilane, phenyltrimethoxysilane, N-[3-(trimethoxysilyl)propyl]-1,2-ethanediamine and acetoxyethyltriethoxysilane, 2-hydroxy-4-(3-triethoxysilylpropoxy)diphenylketone, methyl-triethoxysilane, vinyltrimethoxysilane, (3-glycidoxypropyl)trimethoxysilane, (benzoyloxypropyl)trimethoxysilane, sodium 3-trihydroxysilylpropylmethylphosphonate, 3-(trihydroxysilyl)-1-propanesulfonic acid, (diethylphosphonatoethyl)triethoxysilane, and the mixtures thereof.

9. The method according to claim 4, wherein said solution (S′) is obtained by mixing together:
optionally at least one non-alcohol polar solvent,
at least one alcohol polar solvent, and
at least one compound allowing the hydrolysis of the silane compound.

10. The method according to claim 4, wherein said compound allowing the hydrolysis of the silane compound is selected from the group consisting of ammonia, sodium hydroxide (KOH), lithium hydroxide (LiOH), sodium hydroxide (NaOH), triethylamine and pyridine.

11. A solution (S_{b}) comprising:
one (or more) alcohol polar solvent(s),
at least one non-alcohol polar solvent,
one (or more) silicon phthalocyanine derivative(s) of formula (I): 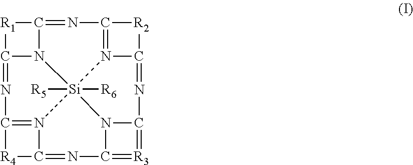
in which:
R₁, R₂, R₃ and R₄, the same or different, are an arylene group, optionally substituted, and
R₅ and R₆, the same or different, are selected from the group consisting of —Cl, —F, —OH and —OR′ where R′ represents an alkyl, straight-chain or branched, having 1 to 12 carbon atoms, optionally substituted,
optionally at least one silane compound, and
at least one compound capable of hydrolysing a silane compound.

12. The solution according to claim 11, comprising:
one (or more) alcohol polar solvent(s) in a quantity of between 20 and 80%,
at least one non-alcohol polar solvent in a quantity of between 15 and 75%
one (or more) silicon phthalocyanine derivative(s) in a quantity of between 10 μmM and 20 mM,
optionally at least one silane compound in a quantity of between 10 μM and 20 mM, and
at least one compound capable of hydrolysing a silane compound, in a quantity of between 0.1 and 10%,
the percentages being expressed in volume relative to the volume of said solution.

13. A silica particle comprising at least one phthalocyanine derivative able to be prepared using the method of claim 1, wherein it has a mean size of 105 nm or higher.

14. The method of claim 2, wherein said aryl is a phenol, benqyl or naphthyl.

15. The method of claim 2, wherein said alkyl is a methyl, an ethyl, a propyl or a hydroxypropyl.

16. The method of claim 3, wherein said aryl is a phenol, benqyl or naphthyl.

17. The method of claim 3, wherein said alkyl is a methyl, an ethyl, a propyl or a hydroxypropyl.

18. The method of claim 5, wherein said polar solvent is selected from the group consisting of methanol, ethanol and isopropanol

19. The method of claim 7, wherein said acryloxy group is a methacryloxy group.

20. A silica particle comprising at least one phthalocyanine derivative able to be prepared using a method such as defined in claim 1, wherein it has a mean size between 110 and 600 nm.

21. A silica particle comprising at least one phthalocyanine derivative able to be prepared using a method such as defined in claim 1, wherein it has a mean size between 120 and 400 nm.
